(19) United States
(12) Patent Application Publication
(10) Pub. No.: US 2008/0142644 A1
(43) Pub. Date: Jun. 19, 2008

(54) Flight apparatus having movable motors

(76) Inventor: Corey O'Roark, Kingman, AZ (US)

Correspondence Address: LAW OFFICE OF MICHELE HOLDEN, 212 N. 4TH STREET, SUITE 7, KINGMAN, AZ, 86401, US

(21) Appl. No.: 11/639,829

(22) Filed: Dec. 15, 2006

(51) Int. Cl. B64C 39/02; B64C 19/00

(52) U.S. Cl. 244/4 A; 244/75.1

(57) ABSTRACT

A flight control system for use in flight apparatus wherein the motors are capable of movement in more than one plane with respect to the support member in response to movement of the control member is disclosed herein. Further, a flight apparatus, aircraft, spacecraft, and personal flight means, having motors that are moveably attached to the flight apparatus such that the motors are capable of movement in more than one plane with respect to the body of the flight apparatus is disclosed.

### BACKGROUND

1. Field of the Invention

The present invention relates generally to flight apparatus and more particularly to flight apparatus having movable motors.

2. Background of the Invention

Flight apparatus, such as aircraft and spacecraft, and personal flight means, and the like are well known in the art. Aircraft include fixed-wing, movable-wing, jet-propelled, propeller-propelled, and rotary apparatus. Aircraft further includes vertical take-off and landing (VTOL) aircraft such as disclosed in U.S. Pat. No. 5,115,996 to Moller. Space craft include rockets, special space transport, and the like. Flight apparatus further include personal flight means, including such as disclosed in U.S. Pat. No. 3,021,095, to Moore, U.S. Pat. No. 3,184,183 to Piasecki, U.S. Pat. No. 3,443,775 to Williams, turbo-fan lift devices such as disclosed in U.S. Pat. No. 3,023,980 to Martin and Cummings, vertical take-off and landing platforms such as disclosed in U.S. Pat. No. 2,953,321, propulsion units for lunar operations such as disclosed in U.S. Pat. No. 3,570,785 to Croft et al. and aircraft attachable to a pilot's body such as disclosed in U.S. Pat. No. 4,253,625 to Dmitrowsky, and the like.

With the exception of VTOL aircraft, flight apparatus generally include motors that are fixed with respect to the body of the aircraft. In such cases, the control of the flight apparatus is accomplished by means of a combination of thrust regulation, and by movement of external flight control surfaces such as flaps, ailerons, and the like. In some VTOL aircraft, the thrust producing means is moveable with respect to the aircraft body, but only with a single degree of freedom. That is, the thrust producing means is movable only about the pitch axis. When the aircraft is in take-off mode, the thrust producing means is rotated about the axis such that the direction of the thrust is vertical, i.e., in the direction of the yaw axis. Once the aircraft is in flight, the thrust producing means are (generally gradually) rotated until the direction of thrust is in the direction of the roll axis. In other VTOL aircraft the use of gimbaled or vectored nozzles redirect thrust while the motors are fixed in relation to the aircraft.

In known personal flight means, such as Moore, the single thrust producing means has more than one plane of movement but is also connected to nozzles which may be manipulated to control the direction of flight. Movement of the thrust producing means alone can only control flight on the pitch and roll access. That is to say it can control forward, backward, and lateral movement. It does not control yaw or altitude. Yaw is controlled by nozzle deflection and altitude is controlled by thrust regulation. Accordingly, while the direction of the thrust forces may be moveable it does not control all aspects of flight control and must be augmented with some additional flight control means, in this case deflecting nozzles and thrust regulation. The problem with such configurations is that there is limited stability in the aircraft. That is to say multiple means of control input make it less intuitive to fly.

### SUMMARY OF THE INVENTION

The present invention comprises a flight control system for use in flight apparatus wherein the motors are capable of movement in more than one plane with respect to a support member in response to movement of a control member.

The present invention further comprises a flight apparatus, such as an aircraft, spacecraft, and personal flight means, having motors that are moveably attached to the flight apparatus such that the motors are capable of movement in more than one plane with respect to the body of the flight apparatus.

### BRIEF DESCRIPTION OF THE DRAWINGS

FIG. 1 is a schematic side view of an embodiment of a personal flight means having moveable motors in accordance with the present invention.

FIG. 2 is a schematic rear view of the personal flight means in FIG. 1.

FIG. 3 is a schematic top view of the personal flight means in FIG. 1.

FIG. 4 is a schematic perspective view of the personal flight means in FIG. 1.

FIG. 5 is a schematic side view of an operator using the personal flight means in FIG. 1, wherein the motors are tilted to generate a forward motion.

FIG. 6 is another schematic side view of an operator using the personal flight means in FIG. 1, wherein the motors are tilted downward to generate a vertical lift.

FIG. 7 is yet another schematic side view of an operator using the personal flight means in FIG. 1, wherein the motors are tilted to generate a backward motion.

FIGS. 8-10 are schematic rear views of an operator using the personal flight means in FIG. 1, illustrating the motors tilted at various angles to control the vertical lift.

FIGS. 11 and 12 are schematic rear views of an operator using the personal flight means in FIG. 1, wherein some of the motors are tilted sideways to generate lateral movements.

FIG. 13 is a schematic top view of an operator using the personal flight means in FIG. 1 and corresponds to FIG. 5.

FIGS. 14 and 15 are another set of schematic top views of an operator using the personal flight means in FIG. 1 and respectively correspond to FIGS. 9 and 10.

FIG. 16 is yet another schematic top view of an operator using the personal flight means in FIG. 1 and corresponds to FIG. 7.

FIGS. 17 and 20 are another set of schematic top views of an operator using the personal flight means in FIG. 1, wherein the motors are tilted to generate yaw motions.

FIGS. 18 and 19 are another set of top views of an operator using the personal flight means in FIG. 1, wherein some of the motors are tilted to generate yaw motions with a large radius of turn.

FIG. 21 shows an embodiment of an unmanned flight apparatus means having moveable motors in accordance with the present invention.

FIG. 22 is a schematic top view of the unmanned flight apparatus shown in FIG. 21.

FIG. 23 shows a schematic side view of an alternative embodiment of a personal flight apparatus having moveable motors in accordance with the present invention.

FIG. 24 is a schematic perspective view of the personal flight apparatus shown in FIG. 23.

FIG. 25 is a schematic side elevation of another alternative embodiment of a flight apparatus having moveable motors in accordance with the present invention.

FIG. 26 is a schematic front view of the flight apparatus shown in FIG. 25.

### DETAILED DESCRIPTION OF THE INVENTION

The present invention comprises a flight control system for an aircraft. A flight control system according to the present invention comprises a support member, at least two motors moveably attached to one or more support members, and control members attached to the motors. According to the present invention, the motors are capable of movement in more than one plane with respect to the support member in response to movement of the control member. In this manner, movement of the motors can control the pitch of the flight apparatus. Similarly, movement of the motors can control the roll of the flight apparatus. Similarly, movement of the motors can control the yaw of the flight apparatus. Similarly, movement of the motors can control the altitude of the flight apparatus.

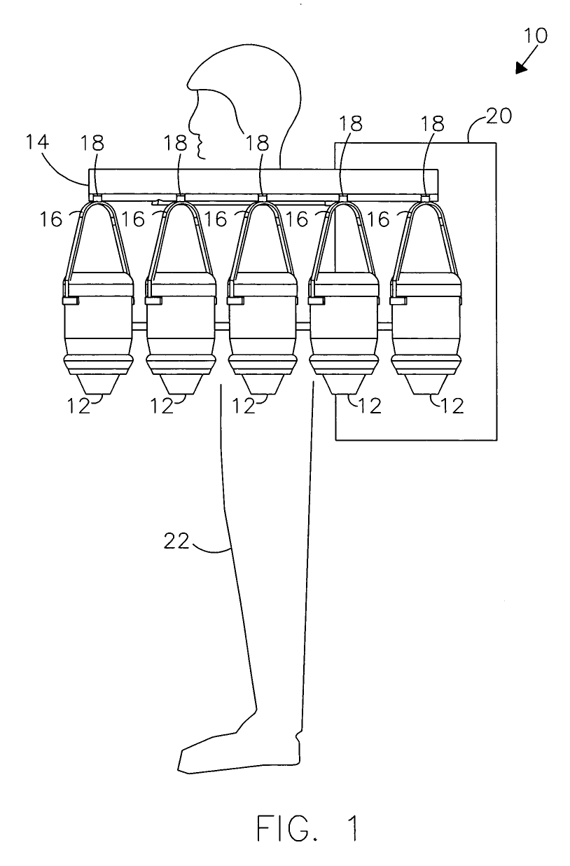

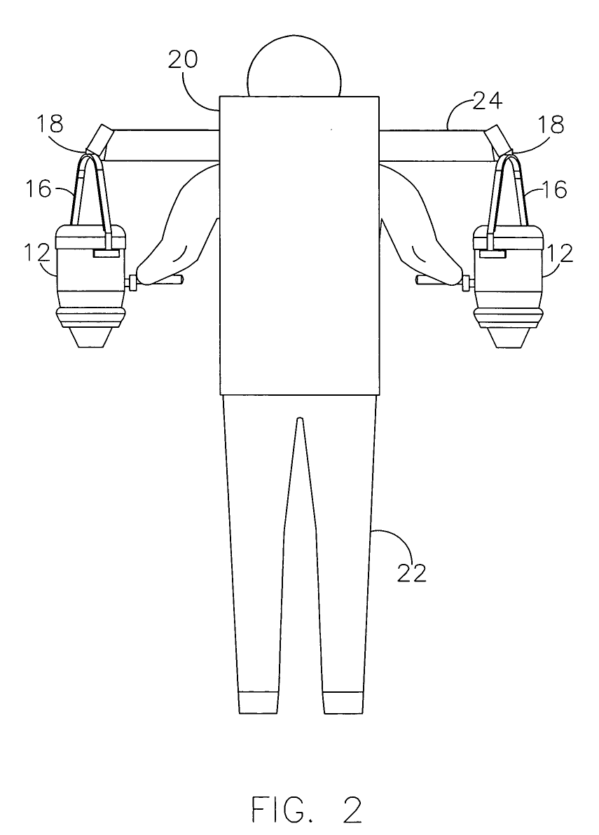

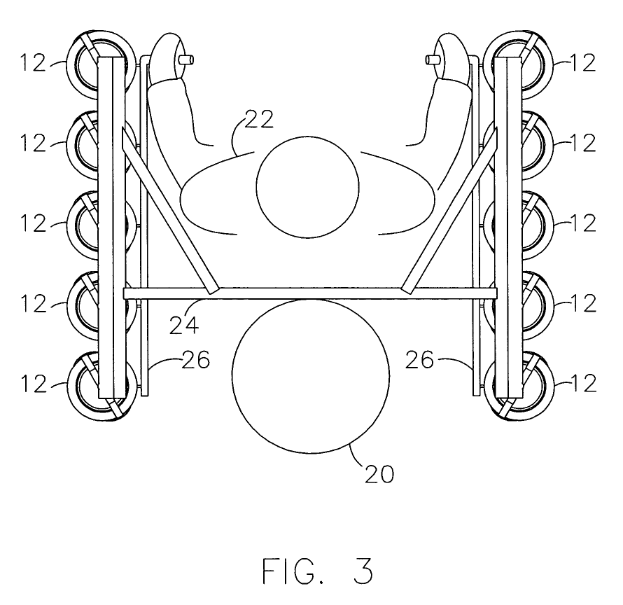

FIG. 1 shows an embodiment of the present invention directed to use in a personal flight means comprising a jet pack. Personal flight means 10 includes a plurality of motors 12 each attached to support member 14 via brackets 16 and ball joints 18 as shown in FIG. 1. Personal flight means 10 further includes fuel tank 20 which is fixedly attached to support member 14. While FIG. 1 shows a left side view of an operator 22 wearing personal flight means 10, it should be understood that the right side view (not shown in FIG. 1) is substantially similar and comprises a plurality of motors attached to a support member fixed attached the fuel tank. Further, it should be understood that the support member could be directly attached to the fuel tank or may be attached via tank support member 24, as shown in FIGS. 2-4. In this manner, the fuel tank and the support members may form the body of the flight apparatus. In alternative embodiment, the body may comprise a frame to which the fuel tank and the support members may be attached. Motors 12 are movable in a forwards and backwards direction, as well as outwardly and inwardly to operator's sides.

As depicted in FIG. 1 the motors are attached to the body via ball joints at the apex of the motors. In alternative embodiments, the motors may be attached at other points of the motor. Furthermore, as would be apparent to one of ordinary skill in the art, the location of the motors with respect to the center of gravity of the flight apparatus may affect the stability of the apparatus in flight. In one embodiment, the motors may be moveably attached to the body of the flight apparatus at or above the center of gravity of the flight apparatus. Similarly, the location of the attachment point on the motors may affect the stability of the flight apparatus. In one embodiment, the motors are moveably attached to the body of the flight apparatus at or above the center of gravity of the motors. It should be understood that the motors could be attached to the body using any suitable means that allows the motors to move in more than one plane with respect to the body of the flight apparatus. Furthermore, the attachment need not be a ball joint but could comprise arms, levers, cables, gimbals, hinges, slides and the like allowing the movement of the motors.

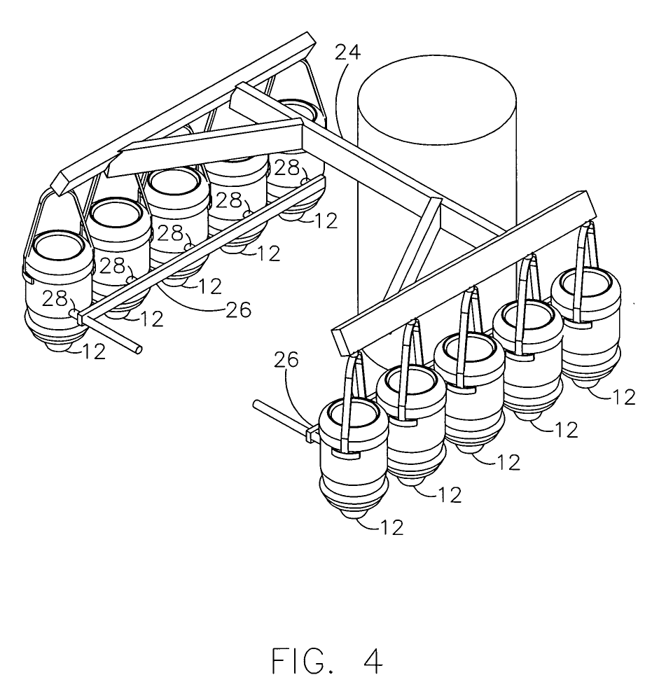

Further, attachment means 28 may be rigid to control member 26, attachment means 18 may be a hinge, and support member 14 may be a slide mechanism. In this manner the motors hinge outwardly and slide forwards and backwards. Further, the control means for moving the motors may be mechanical as shown in FIG. 4. Alternatively, control means for moving the motors could be electronically controlled servos.

As shown in FIG. 4, each of motors 12 are attached to control member 26 via attachment means 28. Attachment means 28 can be any suitable means allowing the motors to freely move generally in unison, in response to a range of movements of the control member. For instance attachment means 28 comprises a bushing and bolt. An operator of personal flight means 10 controls the flight path by movement of the control members. Because the motors are each attached to the support members via ball joints, the motors are moveable in more than one plane with respect to the body of personal flight means 10. Further use of attachment means 28 to connect motors 12 to control members 26 allows each of the motors to move in unison in response to movement of the control means.

An operator of personal flight apparatus 10 is capable of flight controlled completely by the movement of the motors. If the operator wishes to increase altitude, the operator maintains the motors in a vertical attitude. If the operator desires to decrease altitude, the operator raises both sets of motors outwardly to direct the “bleed off” of thrust. The operator can thus control the rate of descent by adjusting the angle of the motors in relation to the horizontal plane. The smaller the angle, the greater the rate of descent as there would be less thrust in the vertical direction. In a similar manner, the operator can control the rate of ascent.

Forward and aft movement is controlled by movement of the control members. If the operator desires to move forward, the operator moves the control members backwards to direct thrust more to the rear. If the operator desires to move backwards, the control members are moved forward to direct the thrust in that direction.

If the operator desires lateral movement, for example to the left, he would raise the right control member outwardly to direct the thrust to his right. To compensate for the reduced vertical thrust, the operator would also lower the left control member to increase vertical thrust.

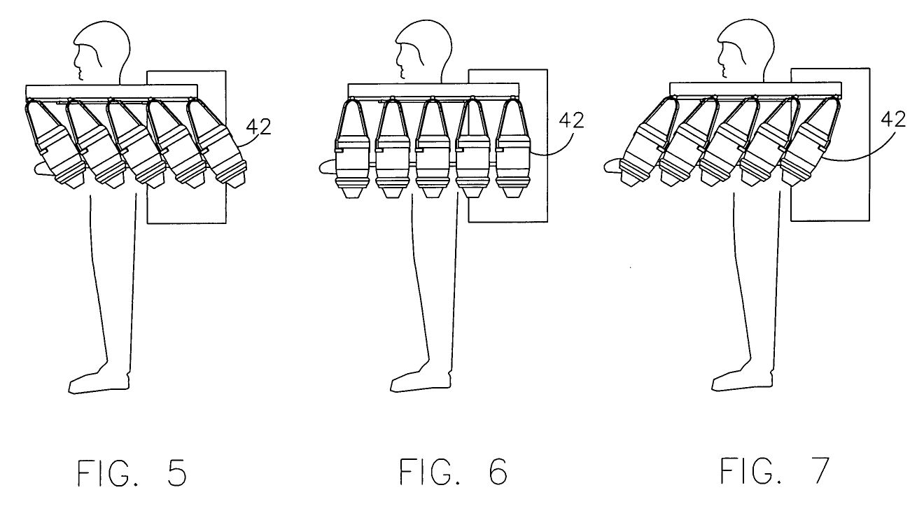

FIGS. 5 through 20 show how differing movements of the motors result in differing movements of the operator through the air or space. These figures, left side motors 42 and right side motors 43 are manipulated by the operator to produce the desired directional movement.

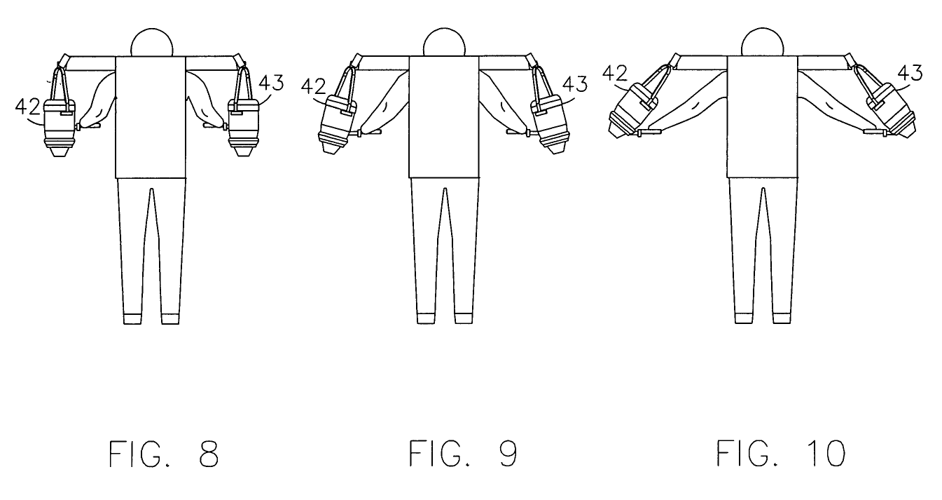

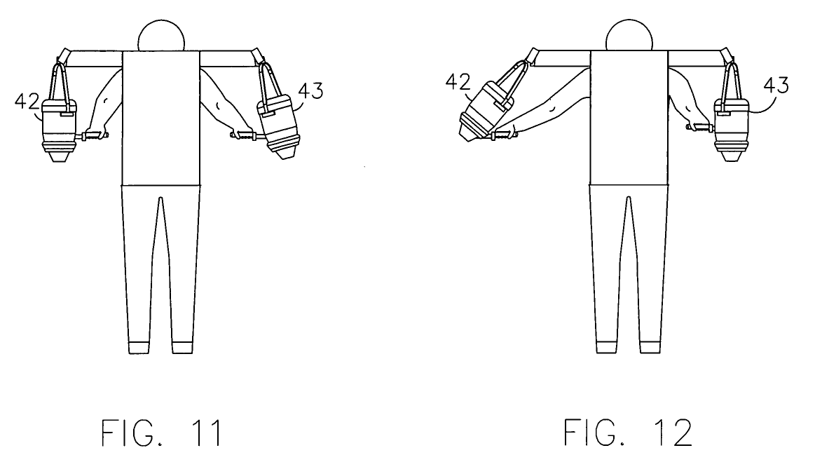

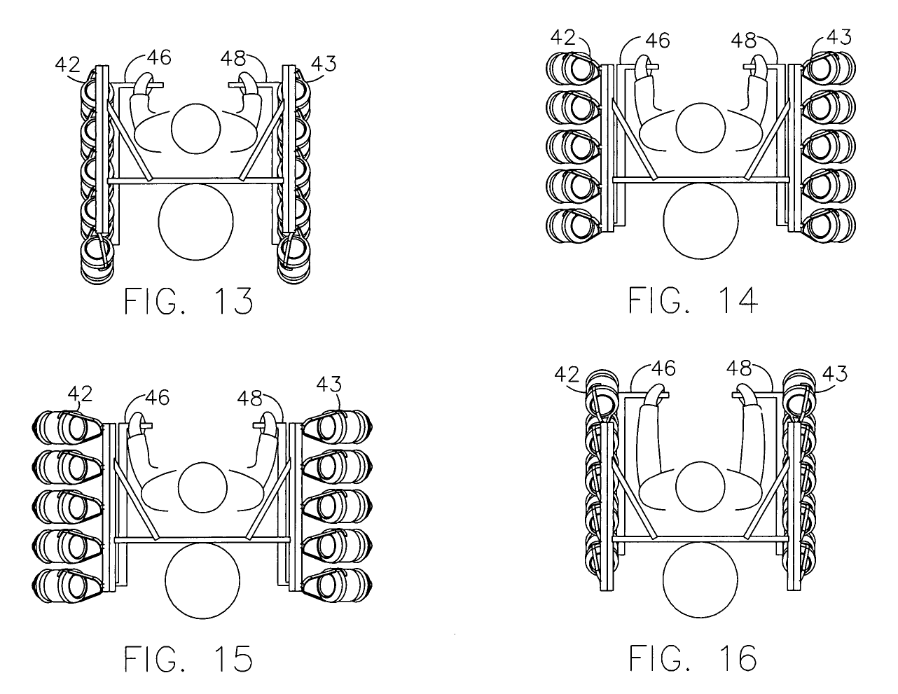

In FIGS. 5 and 13, the operator has both sets of motors pointed backwards which results in a forward movement of the operator. In FIGS. 6 and 8, the operator has both sets of motors pointed downwardly which results in vertical lift of the operator. If the operator raises the motors 42 and 43 sufficiently to his sides, as shown in FIGS. 9 and 14, the operator will hover. As would be apparent to one of ordinary skill in the art, the angle of the motors with respect to the vertical necessary to hold the operator in a hovering position will vary according to the total weight of the system and the amount of thrust produced by each of the motors. Further as would be apparent, as the flight apparatus consumes fuel during flight, the overall weight of the system will be diminished, requiring the operator to change the angle of the motors over time to hold the flight apparatus in a hovering position. In FIGS. 7 and 16, the operator has both sets of motors pointed forwards which results in a backward movement of the operator.

In FIG. 8, the operator has both sets of motors pointed downward which results in vertical (ascent) movement of the operator. As described above, the operator in FIGS. 9 and 14 has both sets of motors pointed outwardly to maintain a hovering position. If the operator raises the thrust producing engines outwardly to a greater angle from the vertical, as shown in FIGS. 10 and 15, the operator will descend. The rate of descent is controller by varying the angle from the vertical. The greater the angle, the faster the descent.

In FIG. 11, the operator has only right side motors 43 raised outwardly to his side, resulting in lateral movement of the operator to his left. In FIG. 12, the operator has only left side motors 42 raised outwardly to his side, resulting in lateral movement of the operator to his right.

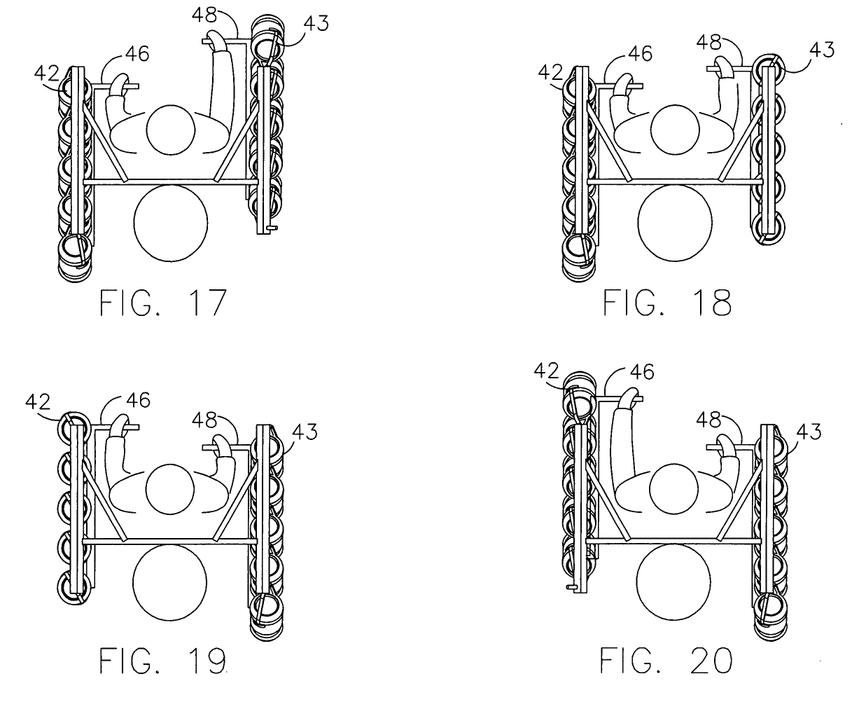

An operator is further able to control his yaw movement in flight by making opposing movements of the control members, thereby directing the thrust in a manner to produce the desired movement. That is, if the operator desires to turn to his right, he would move left control member 46 backward and right control member 48 forward as shown in FIG. 17. In this manner, the direction of thrust on each side will produce the desired movement. If the operator desires to turn to his left, he would move left control member 46 forward and right control member 48 backwards as shown in FIG. 20. Alternatively, for a larger radius of turn, the operator could simply move the right control member backwards, while keeping the left control member in line with the body of the flight apparatus as shown in FIG. 19. Similarly, a turn to the right could be executed by moving the left control member backwards as shown in FIG. 18.

The embodiments of the personal flight means provide safer flight than conventional flight apparatus due to the redundant thrust sources and the more stable flight controls. That is the loss of any one motor can be easily compensated by appropriate movement of the control members. Further, movements of the control members necessary to produce a desired direction of flight are intuitive for an operator. Thrust efficiency is increased over the conventional use of vectored nozzles.

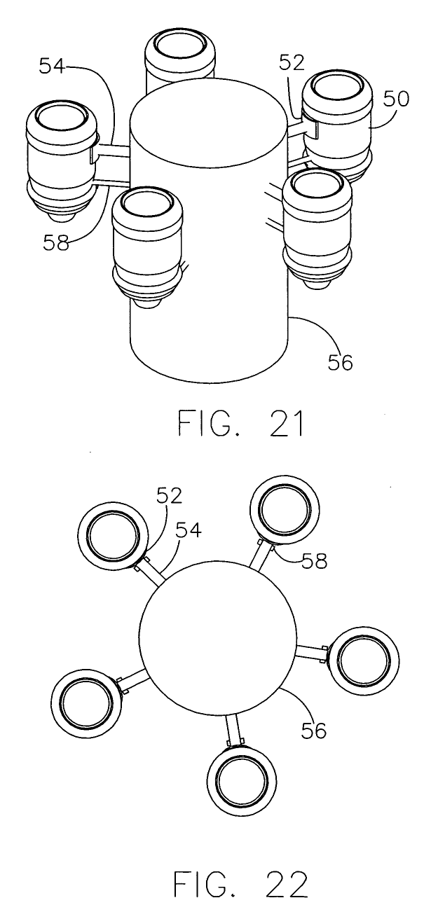

FIG. 21 shows an embodiment of an unmanned flight apparatus means having moveable motors in accordance with the present invention. As depicted, the flight apparatus comprises fuel tank 56 and a plurality of motors 50 attached to the fuel tank via a plurality of support members 54 attached to brackets 52 on the motors. Control of the flight apparatus is achieved by movement of the motors using control members 58. FIG. 22 is a schematic top view of the unmanned flight apparatus shown in FIG. 21. It is noted that the motors need not be in alignment but may be arranged in a circular fashion or in some other configuration.

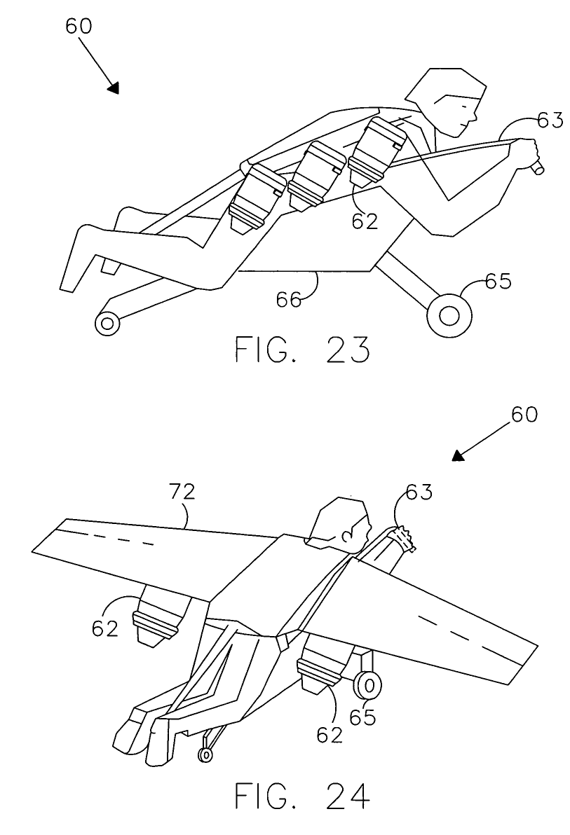

FIGS. 23 and 24 respectively show schematic side and perspective views of an alternative embodiment of a personal flight apparatus in accordance with the present invention. The apparatus shown at 60 is attachable to a pilot's body and comprises moveable motors 62, wings 72, and control member 63. Flight means 60 may further include landing gear 66 and wheel 65 as shown in FIGS. 23 and 24. The use of wings 72 allows for greater fuel efficiency as the wings will contribute to the lift of the craft. Overall, the primary control of flight apparatus is still achieved by movement of motors 62 as described herein. That is, motors 62 are moveable in more than one plane.

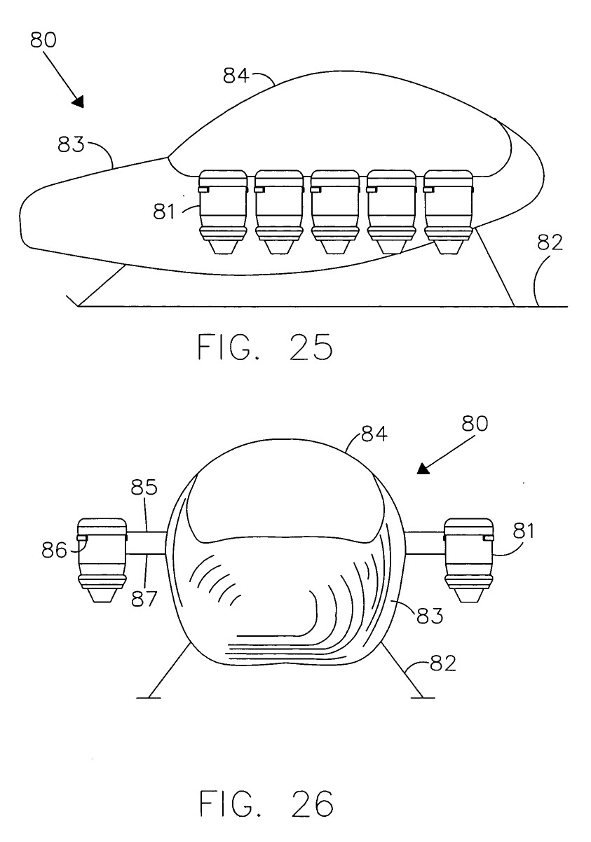

FIGS. 25 and 26 respectively shows side and front views of another alternative embodiment of a personal flight apparatus in accordance with the present invention. Flight apparatus 80 may be adapted to be a personal flight means or a multi-person flight means. Flight apparatus 80 comprises a fuselage or body 83 and moveable motors 81. Flight apparatus 80 may further include windshield 84 and landing gear 82 as shown in FIGS. 25 and 26. Motors 81 are attached to body 83 via a plurality of support members 85 attached to brackets 86 on the motors. Control of the flight apparatus is achieved by movement of the motors using control members 87.

While the foregoing disclosure describes an embodiment of the present invention implemented in a personal flight means, it should be understood that embodiments of the present invention may be implemented in any flight apparatus. Further, motors used in embodiments of the present invention may be jet engines, rocket engines, electric motors, and the like.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A flight apparatus comprising a body, and first and second motors for generating thrust wherein the first and second motors are moveably attached to the body such that the first and second motors are each capable of movement in more than one plane with respect to the body thereby the thrust is controlled.

2. The flight apparatus of claim 1, wherein the more than one plane includes at least two planes of movement.

3. The flight apparatus of claim 1, wherein the more than one plane includes at least three planes of movement.

4. The flight apparatus of claim 1, wherein the first and second motors are independently moveable.

5. The flight apparatus of claim 1, wherein the first and second motors move in unison.

6. The flight apparatus of claim 1, wherein the flight apparatus is a personal flight means.

7. The flight apparatus of claim 6, wherein the personal flight means has a generally jet pack shape.

8. The flight apparatus of claim 1, further comprising a control means for controlling movements of each of the motors.

9. The flight apparatus of claim 8, wherein the control means comprises a mechanical linkage system.

10. The flight apparatus of claim 8, wherein the control means comprises an electronic control system.

11. The flight apparatus of claim 1, wherein the motors are moveably attached to the body at the center of gravity of the flight apparatus.

12. The flight apparatus of claim 1, wherein the motors are moveably attached to the body above the center of gravity of the flight apparatus.

13. The flight apparatus of claim 1, wherein the motors are moveably attached to the body at the center of gravity of the motors.

14. The flight apparatus of claim 1, wherein the motors are moveably attached to the body above the center of gravity of the motors.

15. A flight control system for a flight apparatus comprising:
(a) a support member;
(b) a first motor moveably attached to the support member;
(c) a second motor moveably attached to the support member, the first and second motors being operative to generate thrust; and
(d) a control member attached to each of the motors; wherein the motors are capable of movement in more than one plane with respect to the support member in response to movement of the control member, thereby controlling the thrust.

16. The flight control system of claim 15, wherein movement of the motors controls the pitch of the flight apparatus.

17. The flight control system of claim 15, wherein movement of the motors controls the roll of the flight apparatus.

18. The flight control system of claim 15, wherein movement of the motors controls the yaw of the flight apparatus.

19. The flight control system of claim 15, wherein movement of the motors controls the forward movement of the flight apparatus.

20. The flight control system of claim 15, wherein movement of the motors controls the backward movement of the flight apparatus.

21. The flight control system of claim 15, wherein movement of the motors controls the lateral movement of the flight apparatus.

22. The flight control system of claim 15, wherein movement of the motors controls the altitude of the flight apparatus.

23. The flight control system of claim 15, wherein the motors are moveably attached to the support member at an apex of each of the motors.

24. A personal flight means comprising:
(a) a body;
(b) a first plurality of motors; and
(c) a second plurality of motors, the first and second motors being operative to generate thrust;
wherein the first plurality of motors and the second plurality of motors are moveably attached to the body such that the first and second pluralities of motors are capable of movement in more than one plane thereby controlling the thrust.

25. The personal flight means of claim 24, wherein the body comprises a fuel tank, a first support member, and a second support member, wherein the first support member is fixedly attached to a first side of the fuel tank and the first plurality of motors are moveably attached to the first support member and wherein the second support member is fixedly attached to a second side of the fuel tank and the second plurality of motors are moveably attached to the second support member.

26. The personal flight means of claim 25, wherein the first and second sides of the fuel tank comprise opposite sides of the fuel tank.

27. The personal flight means of claim 24, further comprising a first control means for moving the first plurality of motors with respect to the body.

28. The personal flight means of claim 24, further comprising a second control means for moving the second plurality of motors with respect to the body.

29. The personal flight means of claim 24, wherein the body comprises a frame, a first support member, and a second support member, wherein the first support member is fixedly attached to a first side of the frame and the first plurality of motors are moveably attached to the first support member and wherein the second support member is fixedly attached to a second side of the frame and the second plurality of motors are moveably attached to the second support member.

30. The personal flight means of claim 24, further comprising a landing gear means attached to the body.

31. The personal flight means of claim 24, wherein the body includes a pair of wings for generating lift.

32. A flight control system for a flight apparatus comprising:
(a) a first support member;
(b) a first motor moveably attached to the first support member;
(c) a second support member;
(d) a second motor moveably attached to the second support member, the first and second motors being operative to generate thrust; and
(e) a first control member attached to the first motor;
(f) a second control member attached to the second motor;
wherein the motors are capable of movement in more than one plane with respect to the support member in response to movement of the control members, thereby controlling the thrust.
